(19) United States
(12) Patent Application Publication
(10) Pub. No.: US 2008/0012342 A1
(43) Pub. Date: Jan. 17, 2008

(54) Industrial modular ductwork system

(76) Inventors: Robert E. Elliott, Birmingham, AL (US); Mark V. Downing, Trussville, AL (US); Mark D. Amundsen, Birmingham, AL (US); Clifton B. Thompson JR., Hoover, AL (US)

Correspondence Address: BUSH INTELLECTUAL PROPERTY LAW GROUP, LLC, P.O. BOX 381146, BIRMINGHAM, AL, 35238, US

(21) Appl. No.: 11/589,702

(22) Filed: Oct. 30, 2006

Related U.S. Application Data
(60) Provisional application No. 60/731,743, filed on Oct. 31, 2005.

(51) Int. Cl. F16L 25/00

(52) U.S. Cl. 285/424

(57) ABSTRACT

A modular, uniform system for the design, manufacture, transporting and installation of ductwork has uniform modules that are reinforced with stiffeners and coupled together in pairs. The module pairs are then attached to one another as they are being installed. Additional support beams and struts are also installed on site. As many of the module pairs as are desired may be fitted together to form a duct system of any desired length.

### REFERENCE TO RELATED PATENT APPLICATION

The present application claims priority to U.S. Provisional Patent Application No. 60/731,743, filed Oct. 31, 2005, the disclosure of which is incorporated herein by reference.

### FIELD OF THE INVENTION

The present invention is directed to an industrial ductwork system, and more particularly, to a ductwork system having uniform structural modules to improve design, manufacture, transportation, and assembly of ductwork systems.

### BACKGROUND OF THE INVENTION

Industrial ductwork systems are custom designed, manufactured at a manufacturing facility, transported to a job site, and then assembled. Because of the substantial size of a ductwork structure, the structure must be manufactured in transportable sections, which are subsequently transported to the job site. Transportation of the structural components may require over a hundred transport trucks. Current industrial ductwork systems, which are shipped via truck, do not use uniform modular components. As a result, all steps in the process are more labor intensive and thus more expensive.

For example, the designing step is more labor intensive because the designers must configure the ductwork structure in unique transportable structural sections for delivery to the job site. The manufacturing step is more labor intensive because each structural section is unique, thus custom manufacturing processes are required for each structural section and quality control is thereby complicated. The transportation step is more labor intensive because each structural section is unique such that each transportable load has its own unique issues to be addressed. Finally, assembly is more labor intensive because the structural sections are not uniformly attached to each other, thus assembly is more time-consuming, substantial field welding is typically required, and quality control is thereby complicated.

Accordingly, what is needed, and is not found in the prior art, is a ductwork system having uniform structural modules and easily constructed connections that expedite and facilitate the design, manufacture, transportation, and assembly of ductwork systems.

### SUMMARY OF THE INVENTION

The present invention relates to a modular system of designing, manufacturing, transporting and installing large, industrial ducts primarily designed for conducting gaseous substances such as air. Each module is C-shaped and preferably has more than one stiffener that runs the width of the module as well as a stiffener that runs along the module's periphery and serves as a flange, both strengthening the modules and connecting them to other modules. Two modules are fitted together to form a duct unit having a rectangular cross section and a flange on each end. Braces and struts are placed within the duct unit to strengthen the structure. The duct unit is then attached to other duct units also made by pairing two modules together. How many duct units are fastened together will depend on the desired length of the ductwork. Although the modules described herein are intended for large, industrial size ductworks, the same system is readily applied to duct systems of any size.

These and other features of the invention will become apparent from the following detailed description of the preferred embodiment of the invention.

### BRIEF DESCRIPTION OF THE DRAWINGS

FIG. 1 shows two modules of the present invention unassembled.

FIG. 2 shows two modules assembled to form a duct unit of the present invention.

FIG. 3 shows a seam between two modules of the present invention.

FIG. 4 shows a brace and strut joint of the present invention.

FIG. 5 shows another brace and strut joint of the present invention.

FIG. 6 shows another brace and strut joint of the present invention.

FIG. 7 shows various stages of assembly of ductwork sections of the present invention.

FIG. 7A shows the transportation of the present invention.

FIG. 7B shows the off loading of the present invention.

FIG. 7C shows two modules of the present invention being aligned.

FIG. 7D shows support members and struts attached to the present invention.

FIG. 7E shows a duct unit of the present invention being placed upright.

FIG. 7F shows duct units being spliced together.

FIG. 7G shows ductwork sections of the present invention.

### DETAILED DESCRIPTION OF THE PREFERRED EMBODIMENT

The present invention comprises a ductwork system having uniform structural modules to improve design, manufacture, transportation, and assembly of ductwork systems. These modules 10 are comprised of a side plate 14, a top plate 12 and a bottom plate 13 both attached to the side plate. Plates 12 and 14 form an approximately 90° angle and plates 14 and 13 form an approximately 90° angle. Plates 12 and 13 are approximately parallel. Plates 12, 13, and 14 are re-enforced with a series of metal stiffeners 16 that horizontally traverse the plates. The number and size of the stiffeners 16 will depend upon the dimensions of the modules, the strength of the materials used and the anticipated stress applied to the ductwork. In one embodiment, top plate 12 and bottom plate 13 are each approximately 10 feet wide and 10 feet long, while side plate 14 is about 10 feet wide and about 50 feet long. Because of their large size, plates 12, 13 and 14 may be either made from one large plate or several smaller plates welded together. They could also be made from several smaller plates of a composite, plastic or other material.

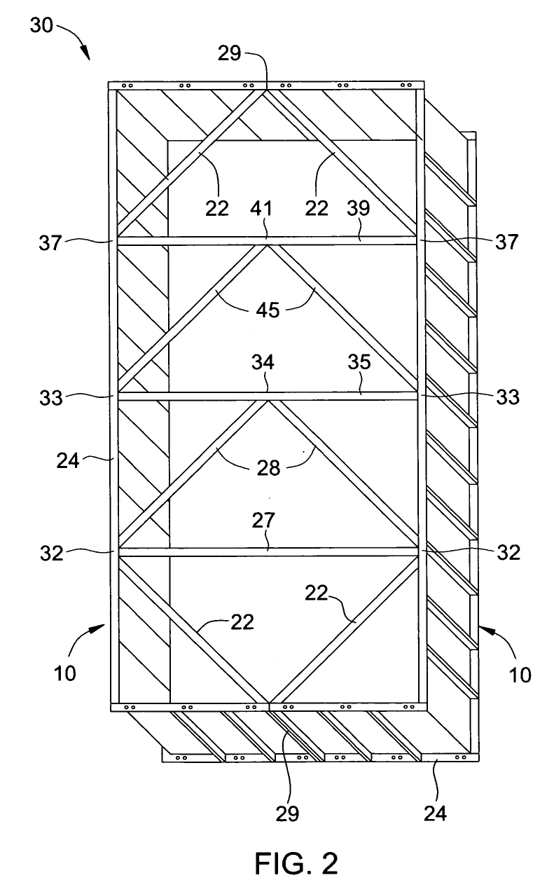

Modules 10 have a top mating stiffener 20 and a bottom mating stiffener 23. Mating stiffeners 20 and 23 have mating points 18. In this embodiment, mating points 18 comprise bolt holes that align with corresponding bolt holes of a mating point on a second module and are used to connect the two modules to one another to form a duct unit 30 as shown in FIG. 2. Mating points 18 are preferably of a simple design, easy to manufacture and facilitate rapid and effective mating of two modules. Therefore, bolt holes such as those shown in the figures are preferred. However, a variety of other mating methods and devices may be used. For example, modules may be spot welded or clamped together. Adhesives may also be used. It may also be desirable to place insulation, a sealant or gasket material between corresponding mating stiffeners prior to connecting two modules. The mating of two modules 10 to form a duct unit 30 results in the forming of mating seam 29 between the mating stiffeners. The seam may be seal welded and/or sealed with a sealant or sealed with a gasket.

Modules 10 also have flange stiffeners 24 on both ends of the module. Flange stiffeners 24 run the entire length of the module 10 each starting at top mating stiffener 20 and continuing to bottom mating stiffener 23. Flange stiffeners 24 have splicing points 19 for connecting to flange stiffeners of other modules. While flange stiffeners are designed to facilitate connection between modules, they also provide structural strength to modules. When two modules are joined to form a duct unit 30, the flange stiffeners 24 of the two modules form complete flanges around the two ends of duct unit 30.

Each module 10 preferably has diagonal support braces 22 that are secured at the manufacturing facility to provide structural support during shipping and handling as well as to the completed ductwork system. Modules 10 each have two braces 22, one attached to top plate 12 and side plate 14, and the other attached to bottom plate 13 and side plate 14. Additional braces and struts are incorporated once two modules have been mated to form a duct section. These braces and struts are typically attached to one of the flange stiffeners, providing a more secure connection.

Metal alloys, composite materials, solid polymeric materials and combinations thereof are suitable for constructing the plates, stiffeners and braces of the modules. Which material is most preferable will depend on the environment that the ductwork system will be in, dimensions of the ductwork and availability of different materials.

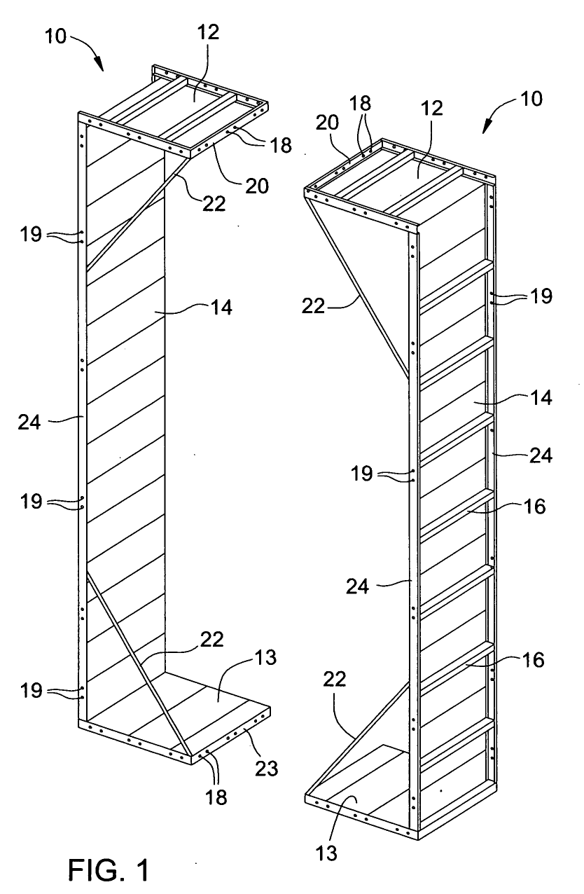

FIG. 2 shows the duct section that results when the modules shown in FIG. 1 are mated and additional support braces and struts have been added. Flange stiffeners 24 form continuous flanges on each end of the duct unit. Strut 27 and braces 28 are attached at joints 32. Strut 35 and braces 45 are attached at joints 33. Braces 28 are attached to strut 35 at its midpoint, joint 34. Strut 39 is attached at joints 37 next to braces 22. Braces 45 are attached to strut 39 at its midpoint, joint 41. This system of braces and struts provides considerable strength to duct section 30 and binds the modules together more firmly than the connections between mating stiffeners 20 and 23 alone.

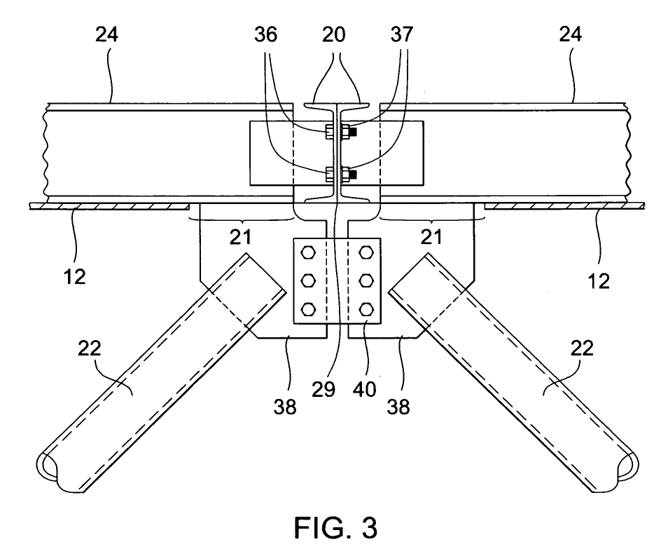

FIG. 3 shows the connection between the top mating stiffeners 20 of two connected modules. It is substantially similar to the connection between bottom stiffeners 23. Top plates 12 are brought together such that the bolt holes of mating points 18 align. Connecting bolts 36 are inserted through holes 18 of both top mating stiffeners 20 and engaged with connecting nuts 37 which are screwed tightly to bolts 36. Also shown are braces 22 attached to gusset plates 38. Braces 22 are slot pipes that have been welded to gusset plates 38. The gusset plates protrude directly from flange stiffener 24 through breaks 21 in top plates 12. To add strength to the connection between modules and to the strut and brace structure, the gusset plates 38 are bolted to a connection plate 40 that holds them firmly in place.

The use of gusset plates, connection plates and slot pipes is well known in the art and are preferred in the present invention because of the ease with which they are assembled and the strength they provide. However, other methods of assembling a support structure may be used.

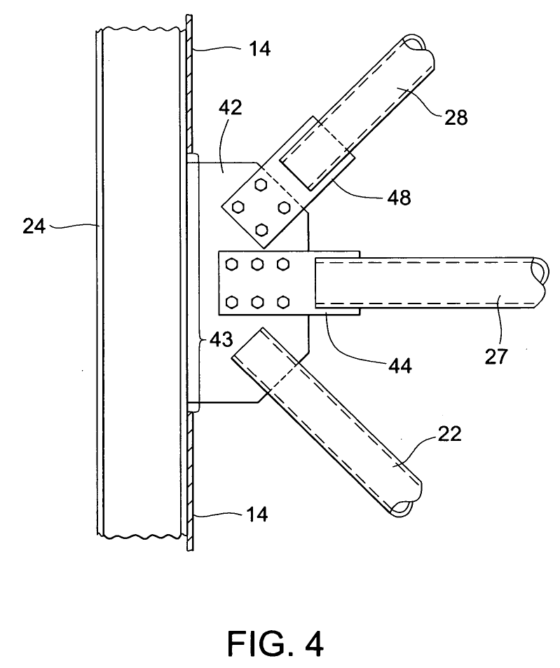

FIG. 4 shows one of joints 32 where braces 22 and 28 and strut 27 are attached to a gusset plate 42 which protrudes directly from splicing stiffener 24 through break 43 in side plate 14. Braces 22 and 28 and strut 27 are preferably all slot pipes. Brace 22 is welded directly to gusset plate 42. Strut 27 is welded to a connection plate 44 which is bolted to gusset plate 42. Similarly, brace 28 is welded to connection plate 48 which is also bolted to gusset plate 42. Those skilled in the art will appreciate the fact that the braces which are installed at the job site are easily bolted in place in lieu of the more common and also more difficult and time consuming field welding process.

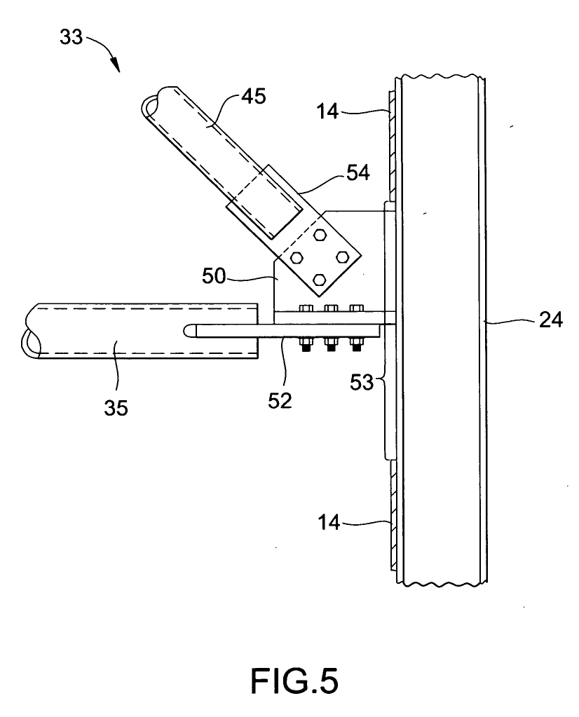

FIG. 5 shows one of joints 33, which is substantially similar to joints 37. Gusset plate 50 protrudes from flange stiffener 24 through break 53. Strut 35 is a slot pipe that is welded to connection plate 52 which is bolted to gusset plate 50. Similarly, brace 45 is a slot pipe that is welded to connection plate 54 which is bolted to gusset plate 50.

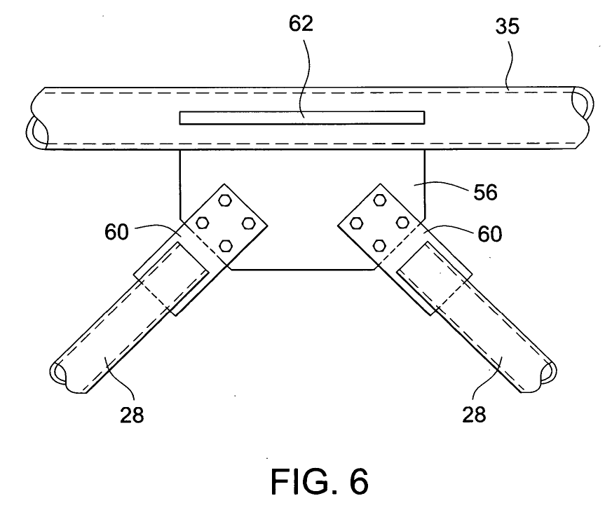

FIG. 6 shows one of joints 34. Strut 35 has gusset plate 56 protruding downward from it. Braces 28 are slot pipes that are welded to connection plates 60 which are bolted to gusset plate 56. A vertical bracing gusset 62 protrudes outward from each side of strut 35 to provide additional strength to joint 34.

Those skilled in the art will appreciate that the design of the reinforcing brace and strut structure described herein is only one of many suitable patterns in which to arrange braces and struts to support the structure of the ductwork system.

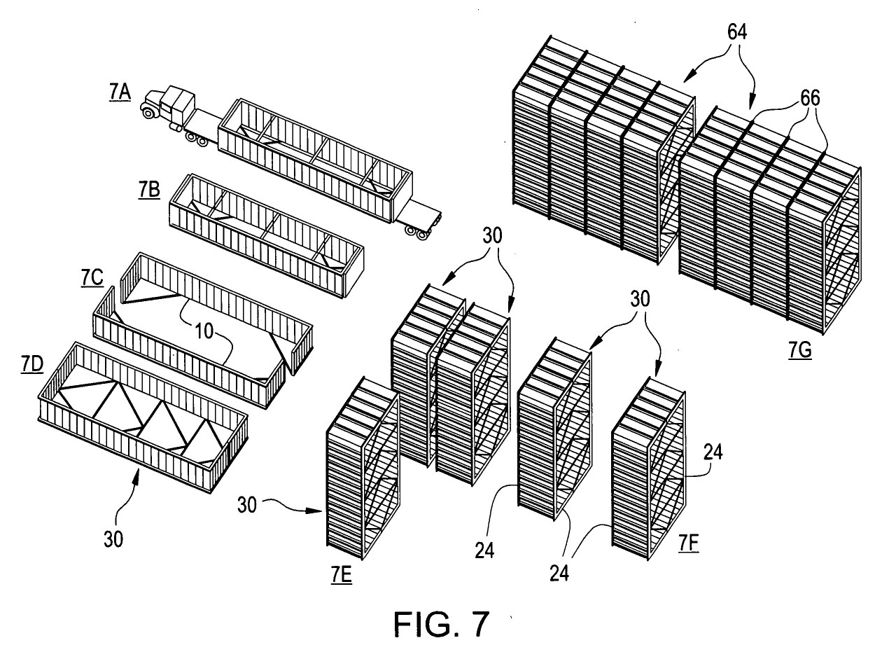

The design of the structural modules 10 facilitates transport to the job site (see FIG. 7A). The modules 10 are off-loaded at the job site (see FIG. 7B), and aligned such that 2 modules face each other, as previously shown in FIG. 1 (see FIG. 7C). They are then secured to each other (see FIG. 7D) to form a 2-module duct unit 30.

After two modules have been connected to one another, struts and braces are added (see FIG. 7D). The duct units are then lifted by a crane and set on end (see FIG. 7E). They are then spliced to other 2-module duct units 30 (see FIG. 7F) by connecting their flange stiffeners 24 at splicing points 19. This process is repeated as many times as desired. FIG. 7G shows two ductwork sections 64 each formed from four duct units 30. Ductwork sections may be longer or shorter depending on the number of duct units 30 are spliced together.

As with mating points 18, splicing points 19 are bolt holes. Two duct sections 30 are placed next to each other such the bolt holes of splicing points 19 are aligned. The two sections are then bolted together. Bolt holes such as those shown in the figures are preferred. However, a variety of other mating methods and devices may be used.

The splicing of two duct units 30 results in seams 66 forming between the connected flange stiffeners. This seam may be welded and/or sealed with a sealant or insulation.

While the invention has been shown and described in some detail with reference to a specific exemplary embodiment, there is no intention that the invention be limited to such detail. On the contrary, the invention is intended to include any alternative or equivalent embodiments that fall within the spirit and scope of the invention as described and claimed herein.

What is claimed is:

1. A modular ductwork system comprising a plurality of C-shaped modules, wherein each of said modules comprises a side plate, a top plate attached to said side plate and forming about a 90° angle therewith, a bottom plate attached to said side plate and forming about a 90° angle therewith, a top mating stiffener attached to said top plate and having mating points, a bottom mating stiffener attached to said bottom plate and having mating points, two ends comprising flange stiffeners having splicing points, and a plurality of stiffeners between and perpendicular to said flange stiffeners.

2. The modular ductwork system of claim 1 further comprising a first brace attached to said top plate and said side plate and a second brace attached to said bottom plate and said side plate.

3. The modular ductwork system of claim 1 wherein said flange stiffeners further comprise gusset plates that protrude through said side plates, said top plates and said bottom plates.

4. The modular ductwork system of claim 1 wherein said mating points of said top mating stiffeners and said mating points of said bottom mating stiffeners comprise bolt holes.

5. The modular ductwork system of claim 1 wherein said splicing points of said flange stiffeners comprise bolt holes.

6. The modular ductwork system of claim 1 further comprising a plurality of duct units, wherein each said duct unit comprises two of said C-shaped modules connected together and a plurality of braces and struts attached to said duct unit.

7. The modular ductwork system of claim 1 wherein said top plates and said bottom plates each have a length of about 10 feet and a width of about 10 feet, and said side plates have a width of about 10 feet and a length of about 50 feet.

8. The modular ductwork system of claim 1 wherein said top plates, said bottom plates and said side plates are comprised of a plurality of plates welded together.

9. A method for assembling a ductwork system comprising the steps of:
a. transporting a plurality of uniform duct modules to a job site, said modules comprising a side plate, a top plate attached to said side plate and forming about a 90° angle therewith, a bottom plate attached to said side plate and forming about a 90° angle therewith, a top mating stiffener attached to said top plate and having mating points, a bottom mating stiffener attached to said bottom plate and having mating points, two ends comprising flange stiffeners having splicing points, and a plurality of stiffeners between and perpendicular to said flange stiffeners;
b. forming a first duct unit by attaching two of said modules together by connecting their said mating points;
c. forming a second duct unit by attaching two of said modules together by connecting their said mating points; and
d. forming a duct section by connecting said splicing points of said flange stiffeners of said first duct unit to said splicing points of said flange stiffeners of said second duct unit.

10. The method of claim 9 wherein said modules further comprise a first brace attached to said top plate and said side plate and a second brace attached to said bottom plate and said side plate.

11. The method of claim 9 further comprising the step of strengthening said first and second duct units by attaching braces and struts to said duct units.

12. The method of claim 11 wherein said flange stiffeners further comprise gusset plates that protrude through said side plates, said top plates and said bottom plates and wherein the step of strengthening said duct units comprises welding and bolting said braces and said struts to said gusset plates.

13. The method of claim 9 wherein said mating points comprise bolt holes and said steps of forming a first duct unit and forming a second duct unit comprise fastening bolts to said bolt holes.

14. The method of claim 9 wherein said splicing points comprise bolt holes and said step of forming a duct section comprises fastening bolts to said bolt holes.

15. The method of step 9 further comprising the step of welding said duct at the points where said modules connect to each other.

16. The method of claim 9 further comprising the step of repeating steps c and d.

17. A method for assembling a ductwork system comprising the steps of:
a. transporting a plurality of uniform duct modules to a job site, said modules comprising a side plate, a top plate attached to said side plate and forming about a 90° angle therewith, a bottom plate attached to said side plate and forming about a 90° angle therewith, a top mating stiffener attached to said top plate and having mating points comprising bolt holes, a bottom mating stiffener attached to said bottom plate and having mating points comprising bolt holes, two ends comprising flange stiffeners having splicing points comprising bolt holes, a plurality of stiffeners between and perpendicular to said flange stiffeners, and a plurality of gusset plates protruding from said flange stiffeners through said side plates, said top plates and said bottom plates;
b. forming a first duct unit by attaching two modules together by connecting their said mating points;
c. strengthening said first duct unit by attaching a plurality of braces and struts to said gusset plates;
d. forming a second duct unit by attaching two modules together by connecting their said mating points;
e. strengthening said second duct unit by attaching a plurality of braces and struts to said gusset plates;
f. forming a duct section by connecting said splicing points of said flange stiffeners of said first duct unit to said splicing points of said flange stiffeners of said second duct unit thereby creating a seam; and,
g. welding said seam.

18. The method of claim 17 further comprising the step of repeating steps d, e and f.
